(19) United States
(12) Patent Application Publication
(10) Pub. No.: US 2015/0326600 A1
(43) Pub. Date: Nov. 12, 2015

(54) FLOW-BASED SYSTEM AND METHOD FOR DETECTING CYBER-ATTACKS UTILIZING CONTEXTUAL INFORMATION

(71) Applicants: George KARABATIS, Ellicott City, MD (US); Ahmed ALEROUD, Baltimore, MD (US)

(72) Inventors: George KARABATIS, Ellicott City, MD (US); Ahmed ALEROUD, Baltimore, MD (US)

(21) Appl. No.: 14/573,796

(22) Filed: Dec. 17, 2014

Related U.S. Application Data
(60) Provisional application No. 61/916,983, filed on Dec. 17, 2013.

(51) Int. Cl. H04L 29/06

(52) U.S. Cl. CPC H04L 63/1433; H04L 63/20

(57) ABSTRACT

A flow-based detection system and method for detection of cyber-attacks is provided that utilizes contextual information to provide improved detection accuracy over existing flow-based systems. Contextual information is utilized to semantically reveal cyber-attacks from IP flows. Time, location, and other contextual information mined from network flow data is utilized to create semantic links among alerts raised in response to suspicious IP flows. The semantic links are identified through an inference process on probabilistic semantic link networks. The resulting links are used at run-time to retrieve relevant suspicious activities that represent a possible attack or possible steps in multi-step attacks.

This application claims priority to U.S. Provisional Application Ser. No. 61/916,983 filed Dec. 17, 2013, whose entire disclosure is incorporated herein by reference.

### BACKGROUND OF THE INVENTION

1. Field of the Invention

The present invention relates to detection of cyber-attacks and, more specifically, to a flow-based detection approach that utilizes contextual information and semantic relations between security incidents to improve detection accuracy.

2. Background of the Related Art

The Background of the Related Art and the Detailed Description of Preferred Embodiments below cite numerous technical references, which are listed in the Appendix below. The numbers shown in brackets (“[ ]”) refer to specific references listed in the Appendix. For example, “[1]” refers to reference “1” in the Appendix below. All of the references listed in the Appendix below are incorporated by reference herein in their entirety.

Modern intrusion detection systems (IDSs) analyze the content of network packets to predict attacks. However, inspecting individual packets has become a fairly hard task with today's high speed Gigabit networks, which carry vast volumes of network traffic [1]. Therefore, the trend is to investigate new intrusion detection techniques, such as flow-based intrusion detection, where aggregated information from IP flows is analyzed instead of packet content. However, research in flow-based intrusion detection is criticized due to the limited amount of information a flow carries, which may not be adequate for attack prediction tasks.

### SUMMARY OF THE INVENTION

An object of the invention is to solve at least the above problems and/or disadvantages and to provide at least the advantages described hereinafter.

Therefore, an object of the present invention is to provide a system and method for detecting cyber-attacks.

Another object of the present invention is to provide a system and method for detecting cyber-attacks by analyzing IP flows.

Another object of the present invention is to provide a system and method for detecting cyber-attacks by analyzing IP flows using contextual information.

Another object of the present invention is to provide a system and method for detecting cyber-attacks by analyzing IP flows using a semantic link network.

Another object of the present invention is to provide a system and method for detecting multi-step cyber-attacks by a sequence of IP flows using a semantic link network.

Another object of the present invention is to provide a system and method for detecting cyber-attacks by analyzing IP flows using a semantic link network that utilizes time-based and location-based contextual features.

Another object of the present invention is to provide a system and method for detecting cyber-attacks by analyzing IP flows using a semantic link network that utilizes numerical and descriptive contextual features.

Another object of the present invention is to provide a system and method for creating a sematic link network of alerts and benign activities utilizing data from known cyber-attacks.

Another object of the present invention is to provide a system and method for inferring semantic links via similarity between nodes and for augmenting such links using semantic link network theory.

To achieve at least the above objects, in whole or in part, there is provided a method of monitoring a set of unidirectional network packets (“IP Flow”) to identify potential threats, comprising applying a set of classification rules to the IP Flow, determining an initial threat prediction based on the application of the set of classification rules, analyzing the initial threat prediction with a semantic link network, wherein the semantic link network comprises suspicious and benign nodes, and further comprises semantic links among the suspicious and benign nodes that are at least partially weighted based on contextual information, and determining an expanded threat prediction based on the semantic link network analysis, wherein the expanded threat prediction comprises a suspicious activity prediction and/or a benign activity prediction.

To achieve at least the above objects, in whole or in part, there is also provided a method of improving the accuracy of a threat prediction made on a set of unidirectional network packets, comprising analyzing the threat prediction with a semantic link network, wherein the semantic link network comprises suspicious and benign nodes, and further comprises semantic links among the suspicious and benign nodes that are at least partially weighted based on contextual information, and determining an expanded threat prediction based on the semantic link network analysis, wherein the expanded threat prediction comprises a suspicious activity prediction and/or a benign activity prediction.

To achieve at least the above objects, in whole or in part, there is also provided a system for monitoring a set of unidirectional network packets (“IP Flows”) to identify potential threats, comprising a classification module that applies a set of classification rules to the IP Flow and determines an initial threat prediction based on the application of the set of classification rules, and a semantic link network module that analyzes the initial threat prediction with a semantic link network and that determines an expanded threat prediction based on the semantic link network analysis, wherein the expanded threat prediction comprises a suspicious activity prediction and/or a benign activity prediction, wherein the semantic link network comprises suspicious and benign nodes, and further comprises semantic links among the suspicious and benign nodes that are at least partially weighted based on contextual information.

To achieve at least the above objects, in whole or in part, there is also provided a system for monitoring a set of unidirectional network packets (“IP Flows”) to identify potential threats, comprising a set of computer readable instructions stored in a tangible medium that are executable by a processor to apply a set of classification rules to the IP Flow, determine an initial threat prediction based on the application of the set of classification rules, analyze the initial threat prediction with a semantic link network, wherein the semantic link network comprises suspicious and benign nodes, and further comprises semantic links among the suspicious and benign nodes that are at least partially weighted based on contextual information, and determine an expanded threat prediction based on the semantic link network analysis, wherein the expanded threat prediction comprises a suspicious activity prediction and/or a benign activity prediction.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is an example of an alert log raised in response to suspicious flows;

FIG. 2 is a block diagram that illustrates the major components of a flow-based detection system 100, in accordance with one preferred embodiment of the present invention;

FIG. 3 is a flowchart illustrating steps in the operation of the flow-based detection system, in accordance with one preferred embodiment of the present invention;

FIG. 4 is a block diagram of a system for creating the classification model for the classification module and for creating the SLN graphs used by the SLN Module, in accordance with one preferred embodiment of the present invention;

FIG. 5 is a flowchart illustrating steps in the operation of the system of FIG. 4 for creating a classification model, in accordance with one preferred embodiment of the present invention;

FIG. 6 is a block diagram illustrating an initial SLN, in accordance with one preferred embodiment of the present invention;

FIG. 7 is a graph showing the average precision for different forms of SLNs in IP flow mode, in accordance with one preferred embodiment of the present invention;

FIG. 8 is a graph showing the average detection rate for different forms of SLNs in IP flow mode, in accordance with one preferred embodiment of the present invention;

FIG. 9 is a graph showing the average F-score for different forms of SLNs in IP flow mode, in accordance with one preferred embodiment of the present invention; and

FIG. 10 is a graph that shows the ROC for SLNs with and without time and location contextual features using 6 operating points (∂=0.1-0.6), in accordance with one preferred embodiment of the present invention.

### DETAILED DESCRIPTION OF PREFERRED EMBODIMENTS

Throughout the specification, the singular and plural versions of the terms “alert” and “suspicious node” are used interchangeably and both refer to an indication of a possible cyber-attack.

Flow based IDSs investigate and analyze the content of IP flows to detect attacks. A flow-based intrusion detection process complements the typical packet inspection intrusion detection approach [1]. The phrase “IP flow” is defined herein as a set of unidirectional network packets sharing certain characteristics [2]. Flow-based intrusion detection can identify only a subset of cyber-attacks, including denial of service [4], scanning attacks [5], worms [6], and botnets [7].

Typical data mining and pattern recognition techniques lack the effectiveness required to identify the majority of cyber-attacks by only analyzing a few traffic-based features. One possible path to improve the effectiveness of detecting attacks from flows is to aggregate information about suspicious flows using their nominal (flags, protocol, service, etc.) time and location features. This form of aggregation is not yet sufficient to effectively detect attacks since there are several indirect and hidden relationships between suspicious activities identified in IP flows.

Attackers who are able to recognize such relationships can exploit them to execute multi-step attacks. Since it is not straightforward to discover such relationships, it is important to identify those using semantic technologies. In intelligent systems, these relationships need to be produced through an inference process that identifies them with respect to context.

There have been few machine learning techniques utilized in flow-based intrusion detection such as Hidden Markov Models [8] and Support Vector Machines [3] to detect SSH brute force attacks, and entropy [9] to identify anomalies. The Hidden Markov Model and entropy approaches focus only on traffic distribution and temporal relations in order to identify attacks. However, such approaches ignore other forms of relationships (e.g. the features of alerts raised in response to flows). Additionally, in a network environment anomaly patterns are not always indicators of cyber-attacks. The One Class (SVM) approach [3] does not utilize contextual relations in the proposed detection technique.

A Semantic Link Network (SLN) is a loosely coupled semantic data model that can be represented with nodes and edges, and that is used to infer semantic links [10]. SLNs have been utilized in several application domains, such as software engineering, to detect relevant software artifacts [11], knowledge discovery in environmental research [12], and community detection [13]. Groups of nodes in SLNs have common characteristics including context of occurrences. According to Brown et al. [14], context characterizes the environment of an object. It is a dynamic grouping mechanism that encloses all information related to a particular situation.

Several works focus on contextual aspects of entities processed in a context aware system. Examples of contextual aspects are the time and order of events that target an entity, the location of an entity, the events that target it, and its relationship to other entities [15]. Several approaches take advantage of contextual information about security exploits to detect attack scenarios using attack graphs [16]. While attack graphs model the relationships between exploits, they do not support automated reasoning, unlike SLNs.

Accordingly, the present invention provides a flow-based detection approach for detection of cyber-attacks that utilizes contextual information to provide improved detection accuracy over existing flow-based systems. As discussed above, most existing network intrusion detection systems rely on inspecting individual packets, an increasingly resource consuming task in today's high speed networks, due to the overhead associated with accessing packet content.

An alternative approach is to detect attack patterns by investigating IP flows. However, analyzing raw data extracted from IP flows lacks the semantic information needed to discover attacks. The system and methods of the present invention utilize contextual information to semantically reveal cyber-attacks from IP flows. Time, location, and other contextual information mined from network flow data is utilized to create semantic links among alerts raised in response to suspicious IP flows. The semantic links are identified through an inference process on probabilistic SLNs. The resulting links are used at run-time to retrieve relevant suspicious activities that represent possible steps in multi-step attacks.

Contextual semantic relations have not been utilized in conjunction with current state-of-the-art flow-based IDSs. Contextual semantic relations can be generated using several extractable features from suspicious flows such as: 1) the location targeted by suspicious flows; 2) the time and duration of suspicious flows; and 3) other features mined from such flows. The present invention utilizes a flow-based intrusion detection technique that takes advantage of contextual information to identify relations between suspicious activities. Such relations are infused into a SLN of alerts and benign activities (represented as nodes in the network).

Reasoning on SLNs is performed to identify semantic links between these nodes. Semantic links are applied on top of a classification model which investigates, at run-time, incoming flow features and produces an initial prediction as a potential suspicious node in the SLN. Given this initial prediction to a specific flow, the pre-identified semantic links are queried to produce additional relevant nodes that may be part of a multi-step attack. After expanding the initial prediction, feature-based profiles of benign activity are applied as prediction filters (PFs) to minimize the side effects of the expansion performed.

The following example shows the benefit of using contextual information to discover cyber-attacks by analyzing IP flows. One popular category of attacks is that of Secure Shell (SSH) daemons, where a hacker can gain access and potentially control a remote host. Once the host is compromised, it is used for scanning of other systems. While typical intrusion detection techniques might be able to detect this attack, the context under which SSH attacks initiate cannot be easily bounded. For example, an attacker's goal is to compromise web servers to build SSH Brute Force botnet. This form of attack has been described by security experts “There are strong indications that unidentified hackers are currently building a botnet, possibly by exploiting a vulnerability in outdated phpMyAdmin installations, and are using it to launch SSH brute force attacks” [2].

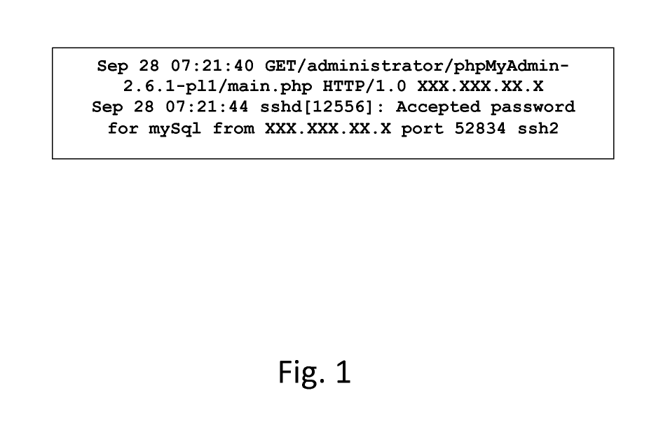

FIG. 1 shows sample entries from alert logs corresponding to suspicious flows from a labeled dataset. The first log entry describes an attacker's attempt to compromise the phpMyAdmin application on a specific server. The second log entry describes a successful brute force attempt on the same server. Based on the time and the location targeted by the initial attempt to compromise the phpMyAdmin and the successful Brute Force, a security specialist, through manual investigation, might infer a relationship between these two activities. However, it might take quite some time to elicit and document such knowledge, due to the large amount of alerts in log entries and unpredictable attacker actions. In many cases, alerts would be irrelevant because the semantic relations between them cannot be explained unless the contextual aspect is considered in analyzing relations. Thus, there is a need to automate the identification and usage of semantic knowledge using contextual information.

In intelligent systems, this knowledge is usually produced through an inference process that identifies relations with respect to context. The proposed approach is driven by database and graph mining techniques to automatically identify and query possible semantic links between different types of suspicious activities. It alleviates the manual and daunting process of human decision making about possible semantic relationships between security incidents. Instead, it automates the process by utilizing an inference process to generate these relationships based on time, location, numerical and textual features of the IP flows and the corresponding security alerts.

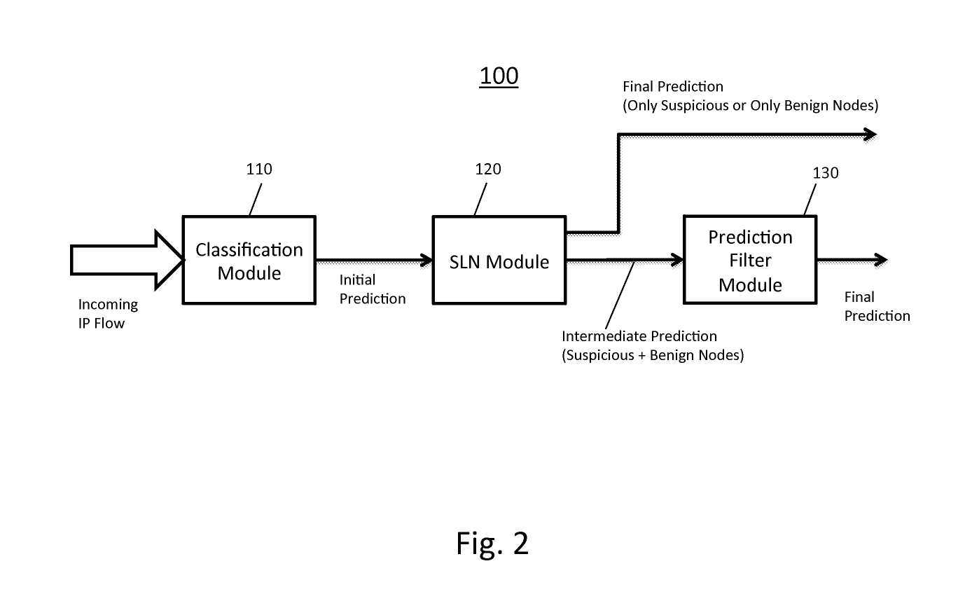

FIG. 2 is a block diagram that illustrates the major components of a flow-based detection system 100, in accordance with one preferred embodiment of the present invention. The system 100 includes a classification module 110, a SLN module 120 and a prediction filter module 130. The classification module 110 receives incoming IP flows and produces initial predictions that are passed to the SLN module 120. The SLN module 120 utilizes a SLN to identify relations between suspicious activities using contextual information. The SLN module 120 expands the initial prediction received from the classification module. If the expanded prediction includes only suspicious nodes or only benign nodes, then the output of the SLN module corresponds to the final prediction.

However, if the expanded prediction includes both suspicious and benign nodes, the SLN module 120 outputs an intermediate prediction that is passed to the prediction filter module 130. The prediction filter module 130 applies feature-based profiles of benign activity to the intermediate predictions as prediction filters (PFs), in order to minimize false positives and false negatives.

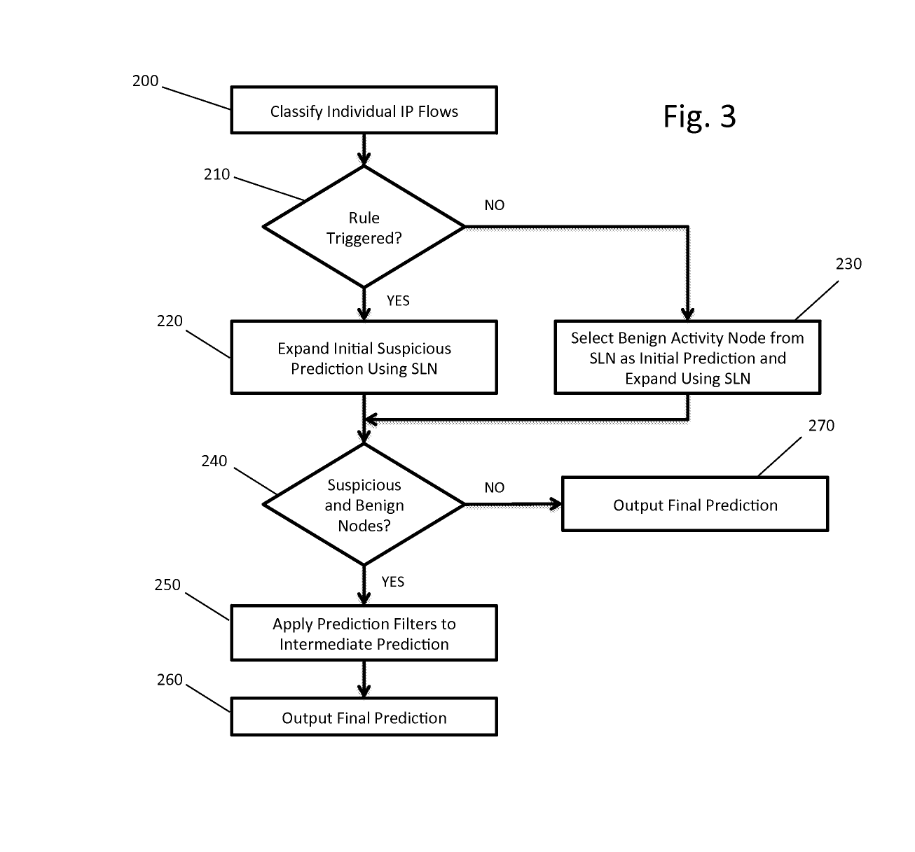

The operation of the various modules in the flow-based detection system 100 will now be described in more detail in connection with FIG. 3, which is a flowchart illustrating steps in the operation of the flow-based detection system 100, in accordance with one preferred embodiment of the present invention.

The attack prediction starts at step 200, in which features of an incoming flow set x={x₁, . . . xₙ} are investigated by the classification module 110 to produce an initial prediction nᵢ for each flow and pass it to SLN module 120. The purpose of this step in attack prediction is to classify individual flows to identify suspicious activities by applying a rule-based classification model, preferably using an ID3 decision tree algorithm.

This rule-based model is utilized at the beginning of the detection process, during which the incoming flow features are the input to the classification rules in the classification module 110. At step 210, it is determined if a classification rule has been triggered. If one of the rules has been triggered, an initial suspicious prediction is passed to the SLN module 120 for expansion using the SLN at step 220. If no rule is triggered, an initial benign activity node is selected from the SLN as an initial prediction and expanded using the SLN at step 230. The benign activity node selected from the SLN depends on the protocol type and flag features of the flow under analysis.

As discussed above, the benign initial prediction is passed to the SLN in the SNL Module 120 at step 230, which expands it to include several other related predictions xₙ_{ᵢ}={n₁, . . . , nₘ}. A flow can be predicted as a suspicious activity (that represents a step in a multi-step attack) or a benign activity. During multi-step attacks, several alerts are raised each one representing an indicator of an attack step. The SLN identifies the possible links between these indicators through their relevance score rs to the initial prediction. An rs threshold ∂ can be used to control the scope of the expansion. For instance, if n₃ is an initial prediction to a specific flow xᵢ and ∂=0.6 the expansion via SLN relations will include n₂ as another prediction to that flow f since rs(n₃→n₂) equals 0.63 and it is greater than ∂.

The SLN may include several nodes which are benign activities, and they may be included in Rₙ_{ᵢ} thus, one may have a scenario where the set of predictions Rₙ_{ᵢ} for a specific flow xᵢ include both suspicious and benign activities. It is then necessary to discard possible inaccurate predictions (i.e., false positives and false negatives). Accordingly, a second decision tree classification model is preferably created to examine flow features to identify benign activities.

Based on the distinct types of protocols found in the observed IP flows, the collected flow data is divided into several disjointed splits that are trained separately. Each split consists of benign and suspicious flows that utilize the same protocol. The outcome of the training phase is a set of several rule-based profiles (prediction filters—“PFs”) which describe different types of benign and suspicious activities. Preferably, only profiles that define benign activities are used since the search is to identify benign activities. Each profile PRᵢ describes one form of benign activity.

PFs are only applied to flows for which the prediction produced include both suspicious and benign nodes. Thus, at step 240 it is determined if the expanded prediction include both suspicious and benign nodes. If it does include both suspicious and benign nodes, then the expanded prediction (intermediate prediction) is sent to the prediction filter module 130, which applies PFs to the intermediate prediction at step 250. For any flow under investigation, if a benign activity bᵢ is triggered and the corresponding benign activity type is included in the SLN predictions, all suspicious predictions made to that flow are discarded by the prediction filter module 130 and only the corresponding benign activity node is kept as a final prediction at step 260. This removes possible false positives.

In contrast, if no benign activity profile is triggered, all benign predictions made to that flow are discarded and only the suspicious predictions are kept as the final prediction at step 260. This removes false negatives. The remaining predictions belong to a possible multi-step attack.

If at step 240, it is determined that the expanded prediction does not include both suspicious nodes and benign nodes, then the expended prediction is output as the final prediction at step 270.

### Foundation for Utilizing Contextual Information to Infer Semantic Links

An aspect of the present invention is the utilization of contextual information to infer semantic links. The preliminary versions of SLNs consist of nodes modeled using a schema. In general, logical reasoning can derive implicit semantic links between SLN nodes through addition and multiplication operations on a node to node relationship matrix using reasoning rules. A SLN schema is defined as described below [13].

SLN Schema:

The SLN schema is a triple denoted by (Nodes, SemanticLinks, Rules). A Node is an object type denoted by nᵢ and its characteristics are represented using a vector \vec{V}ₙ_{ᵢ}=[f₁:dⱼ, . . . , fₘ:d_{y}], where fᵢ is a feature of node nᵢ and dⱼ is the data type of that feature. A SemanticLink is a node x node relation. Each semantic link lᵢ is represented as

$${l}_{i} \text{:} {n}_{i} {->}^{α} {n}_{j} .$$

Each link identifies a possible semantic relation between nodes nᵢ,nⱼ, where α represents a numerical weight on that link.

A Rule is a reasoning mechanism on semantic links. A rule is denoted by

$${n}_{i} {->}^{α} {n}_{j} , {n}_{j} {->}^{β} {n}_{r} ⇒ {n}_{i} {->}^{γ} {n}_{r} \vert α , β , γ$$

are weights on semantic links and α·β [symbol] γ. Based on the rule above, two connected semantic links can lead to a new link. Each implication generated via reasoning can be assigned a certainty degree called relevance score rs. A relevance score can be described in a specific metric space to represent the confidence of an implication generated by semantic reasoning [11]. SLNs are initially represented as a Similarity Relationship Matrix (SRM) defined as follows:

Similarity Relationship Matrix:

Similarity Relationship Matrix (SRM) N is an adjacency matrix where the element αᵢⱼ represents the weight on the semantic link from node nᵢ to nⱼ and αⱼᵢ is the weight on the reverse link from nⱼ to nᵢ. If there are no semantic links between nᵢ and nⱼ, αᵢⱼ=αⱼᵢ=0.

For a given SRM N, the result of αᵢⱼ×αⱼᵣ means that the nᵢ node can reach the nᵣ node in one reasoning step via two semantic links nᵢ→nⱼ and nⱼ→nᵣ. Reasoning steps can be performed by raising the SRM to the power k (i.e., N^{k+1}=N^{k}×N), where nᵢᵣ^{(k+1)} means that node nᵢ can reach node nᵣ in k+1 steps. The number of reasoning steps in a SLN is determined by |N|−1 where |N| is the number of nodes [13]. SLNs can be utilized for reasoning about possible links between the node nᵢ and other nodes in the network. Each node nᵢ in SLN has a relationship with at least one context C. Such a context is defined as follows.

Context (C):

The Context C is a combination of features [f₁:dᵢ, . . . , fₘ:dⱼ] that identify the settings or preconditions under which one or more consequences N′={n₁, . . . , nₖ} are possible to occur in a specific environment |N′⊂N, where N is the set of all possible consequences and k<p|p is their number.

Based on the definition above, there is a cause/effect relation among the features that characterize the context C and the corresponding consequences (e.g., alerts, benign activities). In general, the features identifying context consequences are: numerical, descriptive and time/location-based features. The former two are utilized to create prediction models to identify context consequences such as predicting the type of a suspicious network activity at specific time based on the network traffic features (e.g. source bytes). Additionally, they can be utilized to describe relations among several consequences that are possible in a specific context. The latter (time and location-based features) are dynamic in nature, thus, not feasible to be used as prediction features (e.g. predicting suspicious activities based on the time of the day), but can be utilized to identify relationships among context consequences (e.g., the co-occurrence of two suspicious activities at several time bins). Since each node nᵢ in a SLN is observed in one or more contexts, it represents one possible context consequence. In general, the nodes which are observed in the same context share some common characteristics including semantic closeness.

Proposition:

The strength of semantic links between any two nodes nᵢ, nⱼ calculated via semantic reasoning on a set of paths t₁, . . . , tₘ connecting nᵢ, nⱼ is affected by the context in which the nodes, reached via traversing each of these paths, occur.

Let C₁ and C₂ be two pre-identified contexts where a specific feature f has weights H₁, H₂ calculated using information theory measures such as entropy. The features of each context enable the preconditions that lead to one or more context consequences. H₁, H₂ identify the importance of feature f when observed in predicting these consequences. Using information entropy measures for feature ranking H₁≠H₂ implies that the occurrence pattern of a feature f in both contexts is not the same. That is, the probability of occurrence of f with the consequences observed in C₁ is different compared to its probability with the consequences in C₂. According to the information theory measures introduced by Shannon and the Simplest Emerge Principle (SEP) introduced in [13], the more stable entropy a path (that connects nodes) has, the less information it contains; therefore its semantics can be easily understood.

Let f be a feature used to discriminate among contexts and each consequence be a node on a path. Let n₁, n₂, n₃, n₄ be four nodes in a specific SLN. t₁, t₂ are two paths on that SLN,

$${t}_{1} \text{:} {n}_{1} {->}^{α} {n}_{2} {->}^{γ} {n}_{4} , {t}_{2} \text{:} {n}_{1} {->}^{β} {n}_{3} {->}^{δ} {n}_{4} .$$

α, β, γ, δ represent the weights on links between n₁→n₂, n₁→n₃, n₂→n₄ and n₃→n₄ respectively. The importance of feature f in predicting the occurrence of n₁, n₂, n₃, n₄ can be calculated using conditional entropy as

H(N|f)=Σ_{1≦i≦|N|}Pr(nᵢ,f)log Pr(nᵢ|f) (1)

where Pr(nᵢ, f) is the joint probability of node nᵢ and f, and Pr(nᵢ|f) is the conditional probability of nᵢ given f. If one assumes that H₁=(n₁|f), H₂=H(n₂|f), H₃=H(n₃|f), H₄=H(n₄|f) Using SEP:

|H₁+H₂|>|H₁+H₃| [symbol] β<α (2)

|H₂+H₄|>|H₃+H₄| [symbol] δ<γ (3)

Based on the entropy and probability relation [17], the expression on the left of implication 2 is true if the co-occurrence frequency of n₁ and n₂ when fᵢ is observed (i.e., Pr(n₁, n₂|fᵢ))>Pr(n₁, n₃|fᵢ). Implication 3 is true if (n₂, n₄|fᵢ)>Pr(n₃, n₄|fᵢ). Given these probabilities, the following implications are also true:

Pr(n₁,n₂|f)>Pr(n₁,n₃|f) [symbol] Pr(n₁→n₂|f)>Pr(n₁→n₃|f) (4)

Pr(n₂,n₄|f)>Pr(n₃,n₄|f) [symbol] Pr(n₂→n₄|f)>Pr(n₃→n₄|f) (5)

However, there are two paths between n₁ and n₄,

$${t}_{1} \text{:} {n}_{1} {->}^{α} {n}_{2} {->}^{γ} {n}_{4} and {t}_{2} \text{:} {n}_{1} {->}^{β} {n}_{3} {->}^{δ} {n}_{4} .$$

Based on inequalities (4) and (5), α·γ>β·δ. If a random walker objective is to identify the most feasible semantic link between n₁ and n₄, the path t₁ which contains the nodes that are closer in context is chosen to identify such link, therefore, the above proposition holds.

### Creating the Classification Model for the Classification Module

Let \vec{v}=[f₁:d₁, . . . , fₙ:dₙ] be a set of features extracted from a raw flow. Suppose that a flow classification model m is created using \vec{V} to make an initial prediction nᵢ given a flow xᵢ. Let rs (the relevance score) be the metric that describes the strength of semantic links between predictions where each prediction is represented as a node in the SLN. Given the value of rs, the purpose is to expand each prediction nᵢ made to an individual flow using a classification model m to find other relevant predictions (nodes in SLNs).

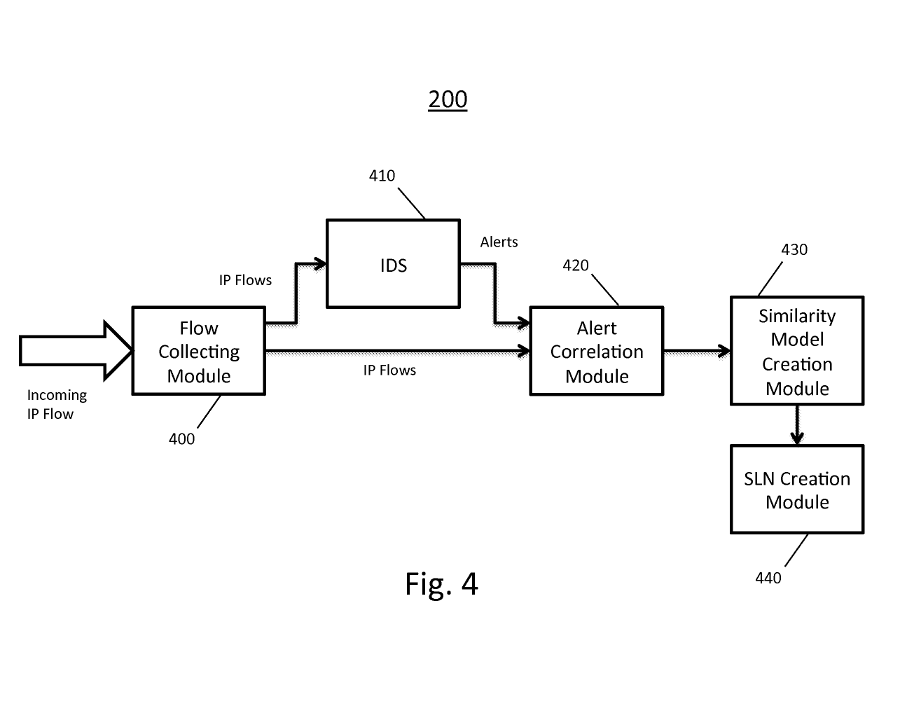

FIG. 4 is a block diagram of a system 200 for creating the classification model for the classification module 110 and for creating the SLN graphs used by the SLN Module 120, in accordance with one preferred embodiment of the present invention. The system 200 includes a flow collecting module 400, an IDS 410, an alert correlation module 420, a similarity model creation module 430 and a SLN creation module 440.

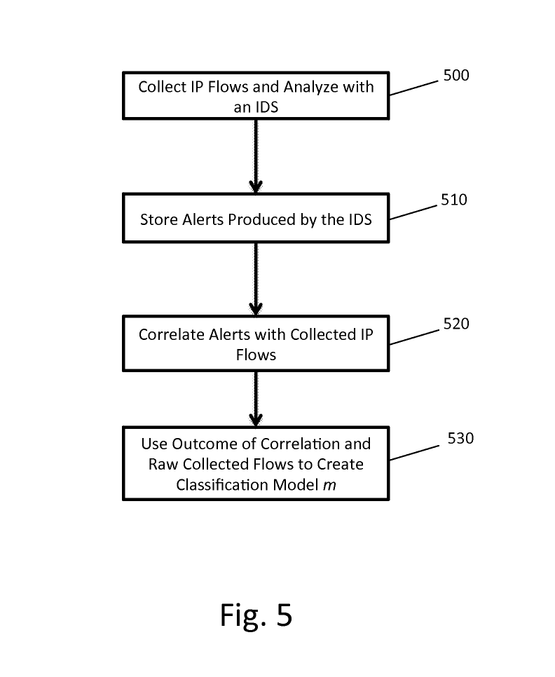

The operation of the system 200 for creation of a classification model will be described in conjunction with FIG. 5, which is a flowchart illustrating steps in the operation of the system 200 for creating a classification model, in accordance with one preferred embodiment of the present invention.

At step 500, the IP flows are collected by the flow collecting module 400 and sent to IDS 410 for analysis. The flow collecting module 400 preferably utilizes flow monitoring techniques that collect and store flows in a specific format for analysis. The collected flows preferably contain at least three types of contextual features: (1) activity features (e.g., numerical and descriptive features); (2) time features; and (3) location features.

The flow preferably has the following structure: x=(I_{src}, I_{dst}, P_{src}, P_{dst}, Prot, Pckts, Octs, Tₛₜₐᵣₜ, T_{end}, Flags), where I_{src} and I_{dst} are the features that identify source and destination IP addresses; P_{src} and P_{dst} are the source and destination ports; Prot is the protocol type; Pckts and Octs give the total number of packets and octets in the data exchange; Flags are the TCP header flags; Tₛₜₐᵣₜ and T_{end} denote the start and end time of the flow respectively.

Data about alerts raised by the IDS 410 in response to suspicious flows is extracted from log files. Such data preferably includes the timestamp of the alert, the alert description in natural language and its category which identifies the type of security incident (e.g., SSH suspicious connection). The features of flows and alerts associated with them represent the metadata that is utilized to identify benign and suspicious activities that are represented as nodes in SLNs.

Next, at step 510, the produced alerts are stored in log files or databases at the alert correlation module 420 for pre-processing. Then, at step 520, the produced alerts are correlated with the raw collected flows by the alert correlation module 420. Each alert can be correlated with one or more IP flows. The candidate flow for each alert is identified based on several flow and alert features such as the source, destination IPs, and port numbers as well as the time of occurrence.

The outcome of such correlation is a set of flows labeled as alerts or benign activities. Using the collected flows, a classification model m is created at step 530 by the similarity model creation module 430 and utilized at run-time in making initial predictions to online (incoming) flows.

### Creating the SLNs

The collected flows and alerts are sent to the SLN creation module 440 by the similarity model creation module 430, and are used to create initial SLN graphs by infusing the contextual features. Each node in the SLN represents an alert or benign activity. Semantic reasoning is performed on initial graphs to produce measurable semantic links among alerts and benign activities. As discussed above, the semantic links between alerts are utilized at run-time to expand the initial prediction, thus identifying possible multi-step attacks and/or semantically relevant activities.

The SLNs are constructed by the SLN creation module 440 by generating weighted links among nodes (e.g., alert types, benign activity types) and then reasoning on such links to augment their semantics. It should be noted that SLNs include both suspicious (alerts) and benign activity nodes. Although alerts and benign nodes have common features, it is expected that semantic reasoning will produce weak relationships between suspicious and benign nodes in SLNs. The SLNs are preferably constructed in two major steps: (1) the creation of weighted links among nodes using similarity; and (2) reasoning on such links to augment the semantic relationships among nodes.

The similarity among nodes is a measure of their co-occurrence. There are three categories of contextual features that have been utilized to calculate similarity. Time/location, numerical, and descriptive features. Time-based features are represented by the timestamp of each alert, the Tₛₜₐᵣₜ, T_{end} of the flows that contain them and the duration of such flows. Location-based features are represented by the source, destination IPs and port numbers (I_{src}, I_{dst}, P_{src}, P_{dst}). These features indicate relations among nodes with regards to source and target of attacks. Numerical features identify traffic statistics, such as the number of packets, octets (Pckts, Octs). Descriptive or nominal features describe other flow characteristics, such as the flags and protocol type (Prot, Flags), in addition to alert description. Some feature types are preferably pre-processed before they are utilized in a similarity calculation. Binning is preferably performed on numerical, time- and location-based features.

After the stop-words are removed, alert description keywords are treated as features. A global node-feature matrix F is created. It consists of all extracted features as rows, the node types as columns, and the normalized frequency of each feature f with each node nᵢ as a weight of f in that node. The previous step gives also one feature vector Vₙ_{ᵢ} per each node type nᵢ.

To start semantic reasoning, initial weights on semantic links among nodes are assigned. The initial weighting criterion is preferably the similarity value of time, location, numerical and/or descriptive features. The measures used to calculate similarity between nodes are preferably Pearson correlation and Anderberg similarity. The purpose of using two similarity coefficients is to measure the sensitivity of the approach to the type of the similarity measure utilized in creating SLNs.

Pearson correlation is preferably utilized since it has been widely used in intrusion detection research [18, 19]. Pearson's correlation coefficient between two nodes nᵢ and nⱼ in SLN is defined as the covariance of their feature vectors cov(σvₙ_{ᵢ}, σvₙ_{ⱼ}) divided by the product of their standard deviation σvₙ_{ᵢ}×σvₙ_{ⱼ}. The similarity results of Pearson's correlation are normalized to the range [0-1].

The Anderberg similarity measure works on binary feature vectors [20] and yields similarity values within [0-1]. A cutoff data transformation technique is preferably used to convert feature vectors to binary format. Given two nodes, nᵢ and nⱼ, each with binary features, the Anderberg coefficient measures the overlap among the features of nᵢ and nⱼ. Each feature of nᵢ and nⱼ can be either 0 or 1, depicting the occurrence or absence of that feature.

After the similarity values are calculated, a similarity relationship matrix N is utilized in modeling the similarity values among nodes and later in semantic reasoning using SLN theory. For example, the matrix N shown below expresses links among five nodes n₁, . . . , n₅. The numbers represent the weights of direct links (i.e. similarity values) between nodes.

$$N = \begin{matrix}{n}_{1} \\ {n}_{2} \\ {n}_{3} \\ {n}_{4} \\ {n}_{5}\end{matrix} {[ \begin{matrix}0 & 0.6 & 0.5 & 0 & 0.1 \\ 0.6 & 0 & 0 & 0.6 & 0.7 \\ 0.5 & 0 & 0 & 0.3 & 0 \\ 0 & 0.6 & 0.3 & 0 & 0 \\ 0.1 & 0.7 & 0 & 0 & 0\end{matrix} ]}^{\begin{matrix}{n}_{1} & {n}_{2} & {n}_{3} & {n}_{4} & {n}_{5}\end{matrix}}$$

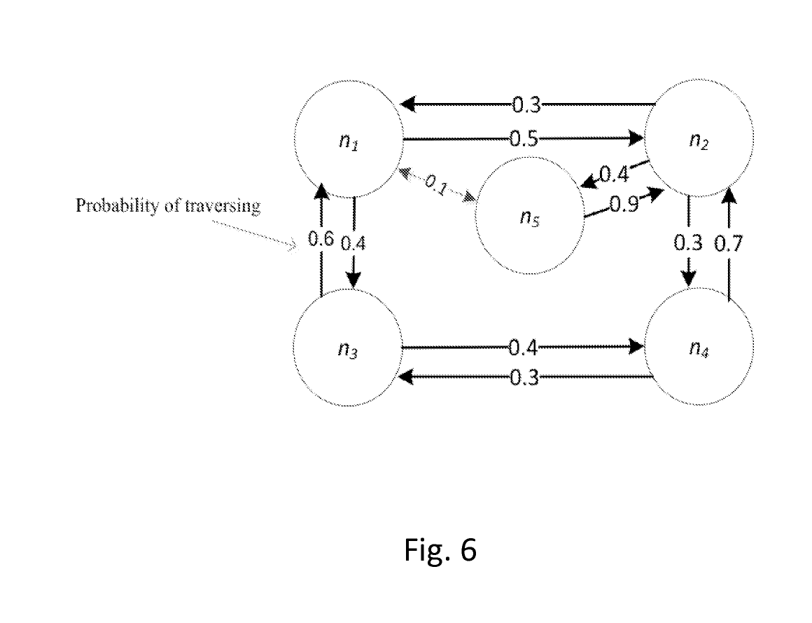

According to the definition of the transition matrices, it is necessary to normalize the weights on links to convert the matrix into a right stochastic matrix. The rows of matrix N are normalized as

$${n}_{i , j} = \frac{{n}_{i , j}}{{Σ}_{m = 1}^{p} {n}_{i , m}} ,$$

where p is the number of columns in N. Once the rows are normalized, an initial SLN is created with weights on edges representing the probability of traversing, as shown in FIG. 6, which is a block diagram illustrating an initial SLN, in accordance with one preferred embodiment of the present invention.

To discover the implicit relationships between a pair of nodes, a reasoning process is performed on the initial SLNs. Initial SLNs are created using similarities that reveal relationships between nodes (alerts). The outcome of reasoning is the degree of relevance (the relevance score) between nodes nᵢ and nⱼ, a metric that measures one or more types of semantic relations between these nodes (e.g. cause-effect, implication, sequential) and it is defined as follows [11].

Relevance Score (RS):

If nᵢ and nⱼ are two nodes of an SLN N and there are m paths t₁, . . . , tₘ between nᵢ and nⱼ where the path tₗ(1≦l≦m) consists of node nₗ_{₁}, . . . ,

$${n}_{{l}_{\vert {t}_{l} \vert + 1}}$$

| (|tₗ| is the length of path tₗ), the rs₍ₙ_{ᵢ}_{→n}_{ⱼ}₎ is defined as min(1,Σₜ_{ₗ}π_{1≦i≦|t}_{ₗ}_{|}SIM(nₗ_{ᵢ},nₗ_{ᵢ₊₁})).

The relevance score rs between nᵢ and nⱼ is calculated as the sum of rs on all paths connecting nᵢ and nⱼ. Each path with length |tₗ| gives one possible rs and it is computed as the product of weights on all edges along that path. Suppose that we want to calculate the rs between n₃ (see FIG. 6) and other nodes in k reasoning steps, where k≦N−1. Using matrix multiplication rules, and for any given pair (nᵢ, nⱼ) with i≠j, the sum of relevance scores for all paths between nᵢ and nⱼ with length |tₗ| is equivalent to Nₙ_{ᵢ}_{,n}_{ⱼ}^{|t}^{ₗ}^{|}, where N^{|t}^{ₗ}^{|} is the product of self-multiplying N, |tₗ| times. For example, the relevance scores between n₃ and other nodes over all paths with lengths 2, 3, 4 and 5 (calculated using the weights shown in FIG. 6) are as follows:

$$\begin{matrix} & & {n}_{1} & {n}_{2} & {n}_{3} & {n}_{4} & {n}_{5} \\ {N}_{{n}_{3}}^{2} -> {n}_{j} & = & [ 0.00 & 0.58 & 0.36 & 0.00 & 0.06 ] \\ {N}_{{n}_{3}}^{3} -> {n}_{j} & = & [ 0.39 & 0.05 & 0.00 & 0.31 & 0.23 ] \\ {N}_{{n}_{3}}^{4} -> {n}_{j} & = & [ 0.04 & 0.63 & 0.25 & 0.02 & 0.06 ] \\ {N}_{{n}_{3}}^{5} -> {n}_{j} & = & [ 0.35 & 0.09 & 0.02 & 0.30 & 0.26 ]\end{matrix}$$

Since there are several relevance scores calculated based on different paths, we select the maximum rs which describes the most feasible link between the corresponding nodes [11]. Therefore, the rs between n₃→n₂ is 0.63 and it is obtained after 3 reasoning steps (path length=4).

The flow-based detection system 100 (which includes the classification module 110, the SLN module 120 and the prediction filter module 130) and the system 200 for creating the classification model and SLN graphs (which includes the flow collecting module 400, the IDS 410, the alert correlation module 420, the similarity model creation module 430 and the SLN creation module 440) are preferably implemented with one or more programs or applications run by one or multiple processors. The programs or applications are respective sets of computer readable instructions stored in a tangible medium that are executed by one or multiple processors.

The processor(s) can be implemented with any type of processing device, such as a special purpose computer, a distributed computing platform located in a “cloud”, a server, a tablet computer, a smartphone, a programmed microprocessor or microcontroller and peripheral integrated circuit elements, ASICs or other integrated circuits, hardwired electronic or logic circuits such as discrete element circuits, programmable logic devices such as FPGA, PLD, PLA or PAL or the like. In general, any device on which a finite state machine capable of running the programs and/or applications used to implement the flow-based detection system 100 can be used as the processor(s).

Further, it should be appreciated that the various modules that make up the flow-based detection system 100 and the system 200 for creating the classification model and SLN graphs could be implemented with a separate processor for each module or any combination of multiple processors. For example, the classification module 110, the SLN module 120 and the prediction filter module 130 could be implemented with programs and/or applications running on a common processor.

### System Evaluation

Evaluating intrusion detection techniques is a challenging task due to lack of labeled intrusion detection datasets. Sperotto et al. [1, 22] were the first who contributed a labeled flow-based dataset intended to train and evaluate flow-based intrusion detection techniques. This dataset contains suspicious flows only. The systems and methods of the present invention requires evaluation on both benign and suspicious traffic, therefore, the dataset was augmented by including benign flows from another benchmark dataset created by Shiravi et al. [23].

The flows selected from both datasets create a synthetic dataset that was used to evaluate the flow-based detection system 100. The data set provided by Sperotto et al. [1, 22] was captured in the University of Twente network by monitoring a honeypot. Most of the collected flows are malicious in nature. Each suspicious flow is correlated with one alert that describes the type of security incident (the label) of that flow. The security incidents in the dataset belong to two categories: (1) basic alerts and/or (2) clustered alerts. Basic alerts represent single security incidents and are directly correlated with one or more flows. Most alerts in this category are HTTP and SSH suspicious connection attempts.

As a side effect of these attempts, ICMP and AUTH/IDENT traffic is generated. Although the side effect flows have not been described as suspicious activities, they were treated as consequences of SSH and HTTP connection attempts. The basic alert description features in this dataset are analyzed. The majority of basic alerts were found to be SSH and HTTP connection attempts. Nevertheless, based on the tcp flags feature 12 distinct SSH scan types were found. Based on the targeted application (e.g., phpMyAdmin, mysql) 11 HTTP alert types were found. These types represent the suspicious nodes in SLNs. These types were considered as ground truth to validate the effectiveness of the system 100 in identifying the type of individual suspicious flow.

Clustered alerts represent logical groups of alerts. They describe attack scenarios during which several suspicious connection attempts are observed. The duration of each attack is between 5 seconds and one hour. The dataset contains 3 types of multistep attacks. The first type represents the SSH scan attempts, which consist of several SSH brute-force attempts. The second type of attacks is the HTTP scan.

As part of scan attacks, side-effect traffic is generated. The third type of attacks is a two-step attack representing attacker's HTTP connection attempts as a consequence, the attacker used the honeypot system itself to launch SSH scans and dictionary attacks. Cluster alerts that aggregate attack steps in this data set are considered as ground truth to measure the effectiveness of the system 100 in detecting multi-step attacks.

574,360 suspicious flows were selected from the suspicious dataset with the corresponding alerts and their types. The selected flows are used in creating SLNs, training the decision tree classifiers and measuring the effectiveness of the system 100 in detecting both suspicious flows and multi-step attacks. The suspicious data is selected from all 6 days in several consecutive time windows with various lengths in order to include the majority of suspicious activity types in the selected data.

During data pre-processing, time bins are manually created. The width of each bin is 25 minutes. To formulate the benign part of the data, traffic data that had been generated via profiling user behavior [23] was relied on. No suspicious flows were selected from this dataset, since it consisted of individual security incidents and it did not have causality information.

From the benign dataset, only features that existed in the malicious dataset were selected. A total of 324,998 benign flows were selected representing 4 types of benign traffic for HTTP, SSH, ICMP and IRC protocols. Each type is represented as a benign node in the SLNs. Table I below shows the characteristics of the selected suspicious flows.

TABLE I
synthetic dataset characteristics

| | # of distinct | # of selected | # of |
|---|---|---|---|
| Activity category | node types | flows | attacks |
| SSH suspicious | 12 | 350000 | 45 scans |
| connection attempts | | | |
| SSH benign traffic | 1 | 7428 | — |
| HTTP suspicious | 11 | 9228 | 4 scans |
| connection attempts | | | |
| HTTP benign traffic | 1 | 315873 | — |
| ICMP side effect traffic | 1 | 16403 | 21 scans |
| IRC side effect traffic | 1 | 7383 | |
| AUTH/IDENT side | 1 | 191325 | — |
| effect | | | |
| ICMP benign traffic | 1 | 1573 | |
| IRC benign traffic | 1 | 124 | |
| Successful login attempts | — | 21 | 21 |
| Total | 26 suspicious | 574360 | 91 |
| | nodes, | suspicious flows, | |
| | 4 benign | 324998 benign | |
| | nodes | flows | |

In this synthetic dataset, the percentage of suspicious to benign flows is 60% to 40%, a distribution similar to the one found in the widely used MIT Lincoln Laboratory intrusion dataset [24]. The time and location features of the selected benign activities have not been utilized in identifying their semantic relations to other nodes. Since benign flows occur all the time, correlating them with suspicious activities based on time and location context results in a fairly high degree of association. It is preferable to reduce the number of edges connecting suspicious and benign nodes.

The synthetic dataset was partitioned as follows: 70% of data was selected to train the decision tree classifiers and create SLNs. The remaining 30% was used for evaluation. The training and evaluation data contain benign and suspicious flows representing different basic alert types, and clustered alerts representing multi-step attacks. The features, Pckts, Octs, Duration (T_{end}−Tₛₜₐᵣₜ), P_{src}, P_{dst}, Flags and Prot were utilized during the training phase of the decision tree classifiers for initial prediction and PF creation. Information Gain (IG) is used as a feature selection technique.

The decision tree classifiers are trained under a 10-fold cross validation setting. Out of the 91 multi-step attacks in the dataset, 50 attacks were used during training and 41 during evaluation. Two types of SLNs were: (1) one without time and location-based features in similarity calculations; and (2) one with time and location. The effectiveness of the system 100 was evaluated in terms of: (1) initial prediction of the actual alert type, if any, using the classification model at the beginning of the detection process; (2) identification of other relevant nodes that belong to a possible multi-step attack using SLNs; and (3) filtering-out false predictions using the benign activity PFs. Precision, Detection Rate, and F-score are the evaluation metrics defined below:

$$\begin{matrix}PR = \frac{TP}{TP + FP} ( 6 ) \\ DR = \frac{TP}{TP + FN} ( 7 ) \\ F = \frac{( 1 + {β}^{2} ) \times PR \times DR}{{β}^{2} \times ( PR + DR )} {β}^{2} = 1\end{matrix} \qquad ( 6 )$$

P, FP, and FN represent true positives, false positives, and false negatives, respectively. A TP represents a suspicious flow correctly recognized as suspicious. TPs for such a flow are expected to be the correct basic alert type nᵢ and other alerts that are semantically related to such alert. This includes other alerts which belong to multi-step attacks in which nᵢ is observed, and/or alerts which cause/caused by nᵢ.

A FP occurs in two cases: (1) when a specific benign flow under evaluation is incorrectly recognized as an alert; and (2) when a specific alert is incorrectly predicted as part of a multi-step attack, but it does not belong to such an attack. A FN occurs when a specific flow under evaluation is an alert, but it is incorrectly recognized as benign activity. The evaluation of the fault-based detection method was performed on a server with Intel Pentium D Dual Core 3.4 GHZ CPU with 8 GB RAM running 64-bit Windows. A prototype implementation of the fault-based detection method was implemented in an Oracle database.

### Effect of Context Infusion in Semantic Links on Detecting Attacks

The first phase in the evaluation process compared the effectiveness of SLNs (P_SLN, AD_SLN) created without time and location features versus (P_SLN_TL, AD_SLN_TL) with time and location features. This evaluation was conducted on the SLNs created using Anderberg (AD_SLN) and Pearson correlation (P_SLN) similarity measures. Relevance score threshold ∂ is used as a tuning parameter to observe the changes in PR, DR and F-score values.

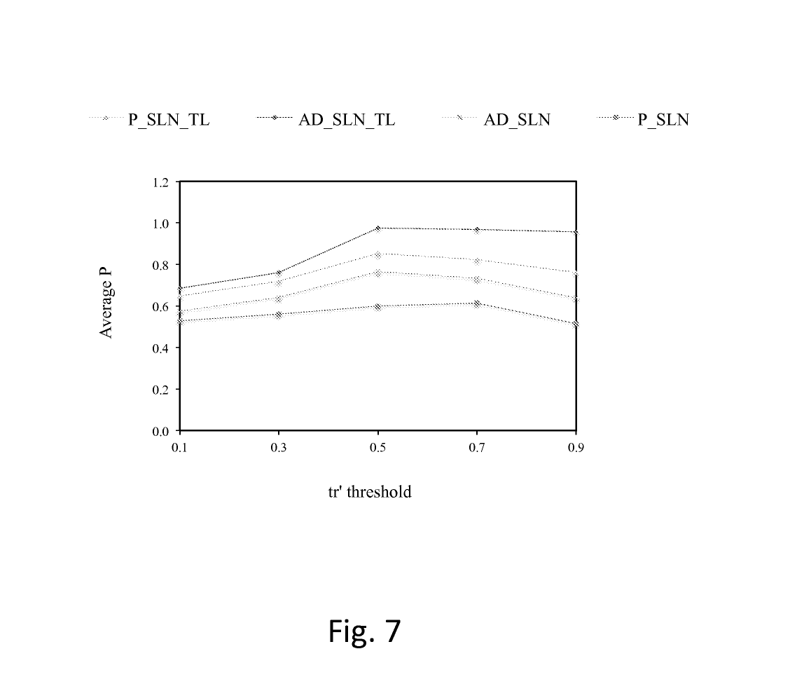

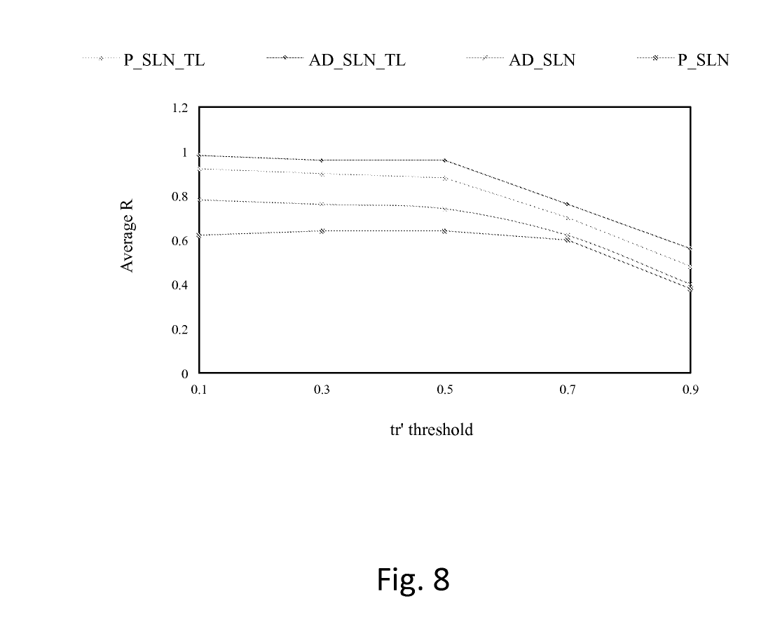

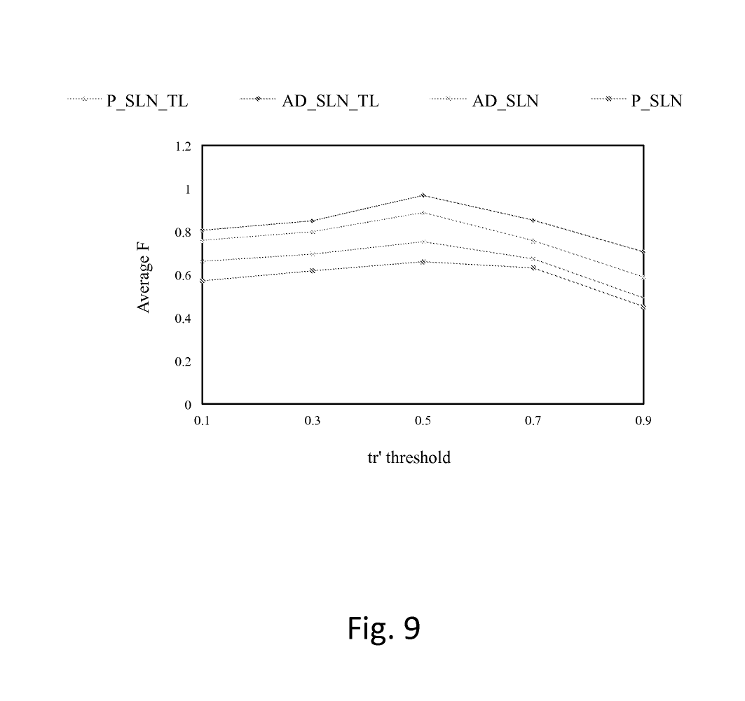

The values of PR,DR and F-score for this evaluation are shown in FIGS. 7, 8 and 9, respectively. FIG. 7 is a graph showing the average precision for different forms of SLNs in IP flow mode, FIG. 8 is a graph showing the average detection rate for different forms of SLNs in IP flow mode and FIG. 9 is a graph showing the average F-score for different forms of SLNs in IP flow mode. The observations in these figures can be summarized as follows.

First, the best PR value (≈0.97) is noticed when ∂=0.6 (FIG. 7). Initially the PR values observed in this evaluation at small values of ∂ are low, indicating that some benign activities were initially predicted as suspicious and, due to the expansion phase, several other suspicious nodes were included as relevant to the initial prediction, resulting in more false positives. With ∂ between 0.4-0.6 better PR values are obtained. The PR decreases again at very high values of ∂, since some TPs that should be included as part of the predicted multi-step attacks are missed due to their weak relation to the initial prediction.

Second, infusing time and location context features in SLNs yields better PR than networks created using only numerical and descriptive features. This is evident in both types of SLNs created using Pearson (P_SLN_TL) and Anderberg (AD_SLN_TL) similarity measures.

Third, although the difference is not very significant, the SLNs created using Anderberg similarity measure (AD_SLN and AD_SLN_TL) achieve better detection rates. Since Anderberg measure does not consider the negative matches (0-0) vector entries in calculating similarity between nodes, it renders itself as a differentiator between suspicious activities that occur in different contexts. Some of these observations are shown in FIG. 8, where the DR values are better when ∂=0.1-0.6, and lower at more refined values of ∂. This decline in DR values is due to the lack of some relevant alerts which are either part of a multi-step attack or semantically relevant to the initial prediction, but that were missed during the expansion made by SLNs.

A similar trend can be seen in FIG. 9, which shows the F-score values at different values of ∂. The best F-score value is 0.97, and it was achieved at a 0.5 value of ∂. These results clearly indicate the positive effects of infusing time and location contextual information on the effectiveness of SLNs to detect attacks.

To measure such an effect in terms of intrusion detection parameters, the Receiver Operating Characteristic (ROC) curve is utilized. The ROC is a popular measure that has been used to compare intrusion detection techniques and to plot TP and FP rates associated with various operating points when different intrusion detection techniques are used. The values of TP and FP rates (TPR and FPR) are calculated as:

$$TPR = \frac{TP}{TP + FN} ( 9 ) \\ FPR = \frac{FP}{FP + TN} \qquad ( 7 )$$

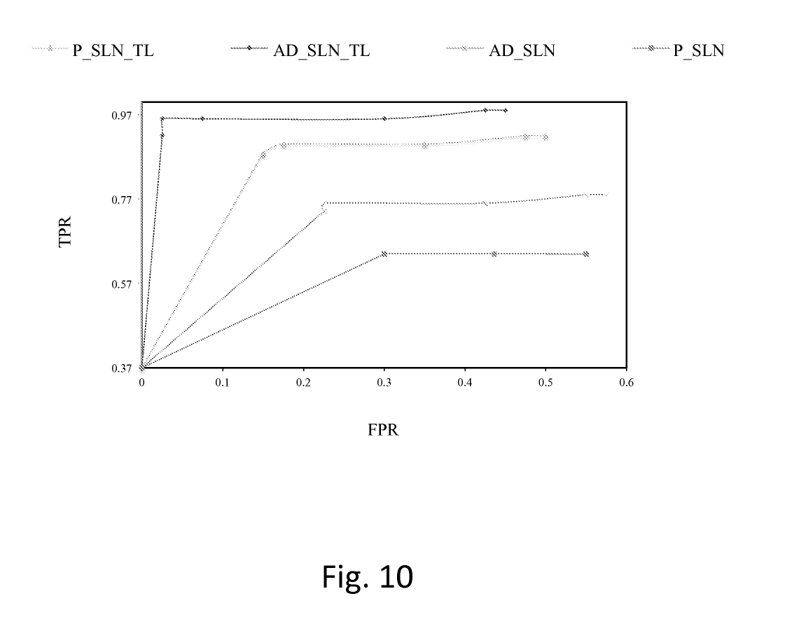

FIG. 10 is a graph that shows the ROC for SLNs with and without time and location contextual features using 6 operating points (∂=0.1-0.6). The results clearly indicate the role of time and location contextual features on increasing TPR and lowering FPR. The main observation is the reduction in FPR when time and location-based features are utilized in creating SLNs. The relations created between nodes using time and location features lead to better identification of nodes that are observed together in several temporal and location bins. This also minimizes overlapping between contexts under which benign and suspicious activities occur.

### Comparison with Other Detection Approaches

An evaluation was conducted to compare the systems and methods of the present invention with the results achieved using other techniques that have been tested on the dataset with suspicious flows. During this evaluation, two approaches were compared: (1) a One Class Support Vector Machine (OCSVM)-based technique to detect malicious activities from flows [3]; and (2) a representative instance selection technique proposed to select representative samples of flows and use them as input to several data mining classification techniques [25]. In order to make the evaluation consistent with the settings of evaluations conducted on these approaches, we minimized the number of benign flows were minimized in the evaluation. In the evaluation conducted on both approaches, the size of benign traffic is small (approximately 1,000 flows) compared to the suspicious traffic. Additionally, the comparison is conducted based on recognizing suspicious activity as suspicious, and benign activity as benign, without focusing on the exact type of the suspicious activity. FPR, Pr, DR and F-score are reported in Table II below.

TABLE II
A COMPARISON WITH OTHER DETECTION APPROACHES

| Approacht | t | t_value | FPR | PR | DR | F |
|---|---|---|---|---|---|---|
| SLNs | ∂ | 0.5 | 0.018 | 0.98 | 0.96 | 0.97 |
| | | 0.6 | 0.017 | 0.98 | 0.92 | 0.95 |
| | | 0.7 | 0.016 | 0.98 | 0.80 | 0.88 |
| | | 0.8 | 0.015 | 0.98 | 0.71 | 0.82 |
| | | 0.9 | 0.015 | 0.98 | 0.68 | 0.80 |
| OCSVMs | γ | 0.25 | 0 | 1 | N/A | N/A |
| [3] | | 0.26 | 0 | 1 | | |
| | | 0.27 | 0 | 1 | | |
| | | 0.28 | 0 | 1 | | |
| | | 0.29 | 0 | 1 | | |
| ANN [25] | N/A | N/A | 0.03 | 0.57 | 0.93 | 0.70 |
| KNN | | | 0.05 | 0.56 | 0.94 | 0.70 |
| SVM | | | 0.03 | 0.50 | 0.96 | 0.66 |
| LibLinear | | | 0.05 | 0.67 | 0.91 | 77.6 |

The tuning parameter γ has no effect on the observed measures in the case of OCSVMs. Additionally, no significant advantage of the optimization procedure followed in the experiments on OCSVMs was seen.

Second, the number of the suspicious flows used during evaluations on OCSVMs was very small (≈23,000). Regarding the second approach, the results reported in the table are the averages under different evaluation settings. The overall values of PR and F-score are lower compared to the SLNs Approach. Although classification and anomaly detection techniques can still work in case of flow-based intrusion detection, the major disadvantage of these techniques is the lack of semantics needed to detect multi-step attacks.

The foregoing embodiments and advantages are merely exemplary, and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. Various changes may be made without departing from the spirit and scope of the invention, as defined in the following claims (after the Appendix below).

### APPENDIX

[1]A. Sperotto, G. Schaffrath, R. Sadre, C. Morariu, A. Pras, and B. Stiller, “An Overview of IP Flow-Based Intrusion Detection,” IEEE Communications Surveys & Tutorials, vol. 12, no. 3, pp. 343-356, 2010.
[2]L. Constantin. (2010, Nov. 15, 2013). Compromised Web Sewers to Build Ssh Brute Forre Botnet [online]. Available: http://news.softpedia.com/news/Compromised-Web-Servers-Used-to-Build-SSH-Brute-Force-Botnet-151779.shtml
[3]P. Winter, E. Hermann, and M. Zeilinger, “Inductive Intrusion Detection in Flow-Based Network Data Using One-Class Support Vector Machines,” in 4th IFIP International Conference on New Technologies, Mobility and Security (NTMS'11), Dubai, UAE, 2011, pp. 1-5.
[4]B. Claise. (2008, 24 Nov. 2013). Specifcation of the Ip Flow Information Export (Ipflx) Protocol for the Exchange of Ip Traffic Flow Information. Available: http://www.ietf.org/rfc/rfc5101.txt
[5]A. Wagner and B. Plattner, “Entropy Based Worm and Anomaly Detection in Fast IP Networks,” in 14th IEEE International Workshops on Enabling Technologies: Infrastructure for Collaborative Enterprise., Modena, Italy, 2005, pp. 172-177.
[6]F. Dressier, W. Jaegers, and R. German, “Flow-Based Worm Detection Using Correlated Honeypot Logs,” in ITG-GI Conference on Communication in Distributed Systems(KiVS), 2007, pp. 1-6.
[7]G. Gu, R. Perdisci, J. Zhang, and W. Lee, “Botminer: Clustering Analysis of Network Traffic for Protocol-and Structure-Independent Botnet Detection,” in Proceedings of the 17th conference on Security (USENIX'08), San Jose, Calif., 2008, pp. 139-154.
[8]A. Sperotto, R. Sadre, P. Boer, and A. Pras, “Hidden Markov Model Modeling of Ssh Brute-Force Attacks,” in Proceedings of the 20th IFIP/IEEE International Workshop on Distributed Systems: Operations and Management (DSOM '09), Venice, Italy, 2009, pp. 164-176.
[9]A. Lakhina, M. Crovella, and C. Diot, “Mining Anomalies Using Traffic Feature Distributions,” SIGCOMM Comput. Commun. Rev., vol. 35, no. 4, pp. 217-228, 2005.
[10]Z. Hai, S. Yunchuan, and Z. Junsheng, “Schema Theory for Semantic Link Network,” in Fourth International Conference on Semantics, Knowledge and Grid (SKG'08), Beijing, 2008, pp. 189-196.
[11]G. Karabatis, Z. Chen, V. Janeja, T. Lobo, M. Advani, M. Lindvall, et al, “Using Semantic Networks and Context in Search for Relevant Software Engineering Artifacts,” Journal on Data Semantics, LNCS 5880, vol. 14, no. pp. 74-104, 2009.
[12]Z. Chen, A. Gangopadhyay, G. Karabatis, M. McGuire, and C. Welty, “Semantic Integration and Knowledge Discovery for Environmental Research,” Journal of Database Management (JDM), vol. 18, no. 1, pp. 43-68, 2007.
[13]H. Zhuge, “Communities and Emerging Semantics in Semantic Link Network: Discovery and Learning,” IEEE Trans. on Knowl and Data Eng., vol. 21, no. 6, pp. 785-799, 2009.
[14]P. J. Brown, J. D. Bovey, and C. Xian, “Context-Aware Applications: From the Laboratory to the Marketplace,” IEEE Personal Communications, vol. 4, no. 5, pp. 58-64, 1997.
[15]A. Zimmermann, A. Lorenz, and R. Oppermann, “An Operational Definition of Context,” in Proceedings of the 6th International and Interdisciplinay Conference on Modeling and Using Context (Context'07), Roskilde University, Denmark, 2007, pp. 558-571.
[16]S. Noel, E. Robertson, and S. Jajodia, “Correlating Intrusion Events and Building Attack Scenarios through Attack Graph Distances,” in 20th Annual Computer Security Applications Conference(CSAC'04), Tucson, Ariz., USA, 2004, pp. 350-359.
[17]T. M. Cover and J. A. Thomas, Elements of Information Theory, Chapter 2: Entrompy, Relative Entropy and Mutual Information John Wiley & Sons, 2012.
[18]W. Qishi, D. Ferebee, L. Yunyue, and D. Dasgupta, “An Integrated Cyber Security Monitoring System Using Correlation-Based Techniques,” in IEEE International Conference on System of Systems Engineering(SoSE'09), Albuquerque, N. Mex., 2009, pp. 1-6.
[19]J. Beauquier and Y. Hu, “Intrusion Detection Based on Distance Combination,” in Proceedings of World Academy of Science: Engineering & Technolog (WASET), 2007, p. 172.
[20]S. Boriah, V. Chandola, and V. Kumar, “Similarity Measures for Categorical Data: A Comparative Evaluation,” in Proceedings of the eighth SL4M International Conference on Data Mining (SDM), Atlanta, Ga., 2008, pp. 243-254.
[21]J. W. Grzymala-Busse, “Selected Algorithms of Machine Learning from Examples,” Fundamenta Informaticae, vol. 1, no. 8, pp. 193-207, 1993.
[22]A. Sperotto, R. Sadre, F. Vliet, and A. Pras, “A Labeled Data Set for Flow-Based Intrusion Detection,” in 9th IEEE International Workshop on IP Operations and Management ((IPOM'09), Venice, Italy, 2009, pp. 39-50.
[23]A. Shiravi, H. Shiravi, M. Tavallaee, and A. A. Ghorbani, “Toward Developing a Systematic Approach to Generate Benchmark Datasets for Intrusion Detection,” Computers & Security, vol. 31, no. 3, pp. 357-374, 2012.
[24]M. Tavallaee, E. Bagheri, W. Lu, and A.-A. Ghorbani, “A Detailed Analysis of the Kdd Cup 99 Data Set,” in Proceedings of the Second IEEE Symposium on Computational Intelgence for Securiy and Defence Applications (CISDA'09), Ottawa, ON, 2009.
[25]C. Guo, Y.-J. Zhou, Y. Ping, S.-S. Luo, Y.-P. Lai, and Z.-K. Zhang, “Efficient Intrusion Detection Using Representative Instances,” Computers & Security, vol. 39, no. p. 255, 2013.

What is claimed is:

1. A method of monitoring a set of unidirectional network packets (“IP Flow”) to identify potential threats, comprising:
applying a set of classification rules to the IP Flow;
determining an initial threat prediction based on the application of the set of classification rules;
analyzing the initial threat prediction with a semantic link network, wherein the semantic link network comprises suspicious and benign nodes, and further comprises semantic links among the suspicious and benign nodes that are at least partially weighted based on contextual information; and
determining an expanded threat prediction based on the semantic link network analysis, wherein the expanded threat prediction comprises a suspicious activity prediction and/or a benign activity prediction.

2. The method of claim 1, wherein the expanded threat prediction comprises a suspicious activity prediction and a benign activity prediction.

3. The method of claim 2, further comprising analyzing the expanded threat prediction with a prediction filter, wherein the prediction filter comprises a set of rule-based profiles that characterize a plurality of predetermined suspicious and benign activities.

4. The method of claim 3, further comprising:
determining if a benign activity is triggered as a result of the analysis with the prediction filter;
if a benign activity is triggered, determining if the triggered benign activity corresponds to the benign activity prediction determined by the semantic link network analysis; and
disregarding the suspicious activity prediction determined by the semantic link network analysis if the triggered benign activity corresponds to the benign activity prediction determined by the semantic link network analysis.

5. The method of claim 3, further comprising:
determining if a benign activity is triggered as a result of the analysis with the prediction filter; and
disregarding the benign activity prediction determined by the semantic link network analysis if no benign activity is triggered.

6. The method of claim 1, wherein the contextual information comprises time-based features and location-based features.

7. The method of claim 6, wherein the contextual information further comprises numerical features and/or descriptive features.

8. A method of improving the accuracy of a threat prediction made on a set of unidirectional network packets, comprising:
analyzing the threat prediction with a semantic link network, wherein the semantic link network comprises suspicious and benign nodes, and further comprises semantic links among the suspicious and benign nodes that are at least partially weighted based on contextual information; and
determining an expanded threat prediction based on the semantic link network analysis, wherein the expanded threat prediction comprises a suspicious activity prediction and/or a benign activity prediction.

9. The method of claim 8, wherein the contextual information comprises time-based features and location-based features.

10. A system for monitoring a set of unidirectional network packets (“IP Flows”) to identify potential threats, comprising:
a classification module that applies a set of classification rules to the IP Flow and determines an initial threat prediction based on the application of the set of classification rules; and
a semantic link network module that analyzes the initial threat prediction with a semantic link network and that determines an expanded threat prediction based on the semantic link network analysis, wherein the expanded threat prediction comprises a suspicious activity prediction and/or a benign activity prediction;
wherein the semantic link network comprises suspicious and benign nodes, and further comprises semantic links among the suspicious and benign nodes that are at least partially weighted based on contextual information.

11. The system of claim 10, wherein the expanded threat prediction comprises a suspicious activity prediction and a benign activity prediction.

12. The system of claim 11, further comprising a prediction filter module that analyzes the expanded threat prediction with a prediction filter, wherein the prediction filter comprises a set of rule-based profiles that characterize a plurality of predetermined suspicious and benign activities.

13. The system of claim 12, wherein the prediction filter module determines if a benign activity is triggered as a result of the analysis with the prediction filter, and disregards the suspicious activity prediction determined by the semantic link network module if the triggered benign activity corresponds to the benign activity prediction determined by the semantic link network module.

14. The system of claim 12, wherein the prediction filter module determines if a benign activity is triggered as a result of the analysis with the prediction filter, and disregards the benign activity prediction determined by the semantic link network module if no benign activity is triggered.

15. The system of claim 10, wherein the contextual information comprises time-based features and location-based features.

16. A system for monitoring a set of unidirectional network packets (“IP Flows”) to identify potential threats, comprising a set of computer readable instructions stored in a tangible medium that are executable by a processor to:
apply a set of classification rules to the IP Flow;
determine an initial threat prediction based on the application of the set of classification rules;
analyze the initial threat prediction with a semantic link network, wherein the semantic link network comprises suspicious and benign nodes, and further comprises semantic links among the suspicious and benign nodes that are at least partially weighted based on contextual information; and
determine an expanded threat prediction based on the semantic link network analysis, wherein the expanded threat prediction comprises a suspicious activity prediction and/or a benign activity prediction.

17. The system of claim 16, wherein the expanded threat prediction comprises a suspicious activity prediction and a benign activity prediction.

18. The system of claim 16, wherein the set of computer readable instructions stored in a tangible medium are executable by a processor to analyze the expanded threat prediction with a prediction filter, wherein the prediction filter comprises a set of rule-based profiles that characterize a plurality of predetermined suspicious and benign activities.

19. The system of claim 18, wherein the set of computer readable instructions stored in a tangible medium are executable by a processor to determine if a benign activity is triggered as a result of the analysis with the prediction filter, and to disregard the suspicious activity prediction determined by the semantic link network module if the triggered benign activity corresponds to the benign activity prediction determined by the semantic link network module.

20. The system of claim 18, wherein the set of computer readable instructions stored in a tangible medium are executable by a processor to determine if a benign activity is triggered as a result of the analysis with the prediction filter, and to disregard the benign activity prediction determined by the semantic link network module if no benign activity is triggered.

21. The system of claim 16, wherein the contextual information comprises time-based features and location-based features.
